(19) United States
(12) Patent Application Publication
(10) Pub. No.: US 2020/0213455 A1
(43) Pub. Date: Jul. 2, 2020

(54) IMAGE FORMING APPARATUS, IMAGE FORMING METHOD, NON-TRANSITORY COMPUTER-READABLE RECORDING MEDIUM STORING PROGRAM, AND PRINT SYSTEM

(71) Applicant: SHARP KABUSHIKI KAISHA, Sakai City (JP)

(72) Inventor: SINTAROU OGINO, Sakai City (JP)

(21) Appl. No.: 16/727,834

(22) Filed: Dec. 26, 2019

(30) Foreign Application Priority Data
Dec. 28, 2018 (JP) 2018-247770

(51) Int. Cl. H04N 1/00

(52) U.S. Cl. CPC H04N 1/00212; H04N 1/00233

(57) ABSTRACT

An image forming apparatus that can be connected to a messaging service that displays a message in a chronological order in timeline includes: an acquisition device that acquires an image displayed in the timeline; and a printer that prints the image acquired.

### BACKGROUND OF THE INVENTION

### Field of the Invention

The present invention relates to an in: forming apparatus, an image forming method, a non-transitory computer-readable recording medium storing program, and a print system.

### Description of the Background Art

Conventionally, a so-called network print service has been proposed in which a user uploads data such as image data using a network such as the Internet, and outputs the uploaded data from a multifunction peripheral installed in a store or the like.

In addition, in a technique that is proposed in Japanese Unexamined. Patent Application Publication No, 2007-243319 and is related to a terminal capable of communicating with at least one image processing apparatus via the network, the terminal includes: a personal information reader that reads personal information; and a notifying unit that notifies a user of presence of an unprinted image in the case where the unprinted image related to the user who corresponds to the personal information read by the personal information reader exists in an image managing unit that manages images per user.

In the conventional technology, in order to be notified that there is the unprinted image, it is necessary to register the user in the network print service. In addition, when printing, the user has to enter information, such as a user number for specifying the user and a document number for specifying data to be output, to the multifunction peripheral.

The multifunction peripherals used by the users for the network print service are mainly installed in public spaces (so-called public places). A speed and simplicity are requested for the use of the multifunction peripheral in the public space. Thus, there is a problem that a method for the user to enter the user number and a document number impairs usability by the user.

In view of the above-described problem, an object of the present invention is to provide an image forming apparatus and the like capable of appropriately outputting image data posted to a messaging service from the image forming apparatus.

### SUMMARY OF THE INVENTION

In order to solve the above-described problem, an image forming apparatus according to the present invention is an image forming apparatus capable of being connected to a messaging service that displays a message in a chronological order in timeline, and includes an acquisition device that acquires an image displayed in the timeline, and a printer that prints the image acquired.

An image forming method according to the present invention includes being connected to a messaging service that displays a message in a chronological order in timeline and acquiring an image displayed in the timeline, and printing the image acquired.

A non transitory computer-readable recording medium storing a program according to the present invention causes a computer to implement an acquisition function of being connected to a messaging service that displays a message in a chronological order in timeline and acquiring an image displayed in the timeline, and a printing function of printing the image acquired.

A print system according to the present invention is a print system including a terminal capable of being connected to a messaging service that displays a message in a chronological order in timeline, and an image forming apparatus, the terminal includes a display that displays the message in the chronological order in a timeline screen, and a sending device that sends an image displayed in the timeline to the messaging service, and the image forming apparatus includes an acquisition device that acquires the image sent to the messaging service; and a printer that prints the image acquired.

According to the present invention, it is possible to appropriately output posted image data from the image forming apparatus simply by posting the image data desired to be output from the image forming apparatus to the messaging service.

### BRIEF DESCRIPTION OF THE DRAWINGS

FIG. 1 is a view for explaining an overall configuration of a print system in a first embodiment.

FIG. 2 is a diagram for explaining a functional configuration of a terminal in the first embodiment.

FIG. 3 is a table illustrating an example of a data configuration of a message storage area in the first embodiment.

FIG. 4 is a diagram for explaining a functional configuration of a message server in the first embodiment.

FIG. 5 is a diagram for explaining a functional configuration of an image forming apparatus in the first embodiment.

FIG. 6 is a sequence chart in the first embodiment.

FIG. 7 is a sequence chart in the first embodiment.

FIG. 8 is a sequence chart in the first embodiment.

FIG. 9 is a view illustrating an operation example in the first embodiment.

FIG. 10 is a sequence chart in a second embodiment.

FIG. 11 is a view illustrating an operation example in the second embodiment.

FIG. 12 is a sequence chart in a third embodiment.

FIG. 13 is a view illustrating an operation example in the third embodiment.

FIGS. 14A and 14B include views of operation examples described in Osaka and Fukuoka dialects in the fourth embodiment.

FIG. 15 is a sequence chart in a fifth embodiment.

FIGS. 16A and 16B include views illustrating an operation example in the fifth embodiment.

FIG. 17 is a view illustrating an operation example in a sixth embodiment.

### DESCRIPTION OF THE PREFERRED EMBODIMENTS

A description will hereinafter be made on embodiments of the present invention with reference to the drawings. In the present embodiment, a description will be made on a print system to which the present embodiment is applied as an example.

### 1. First Embodiment

1.1 Overall Configuration

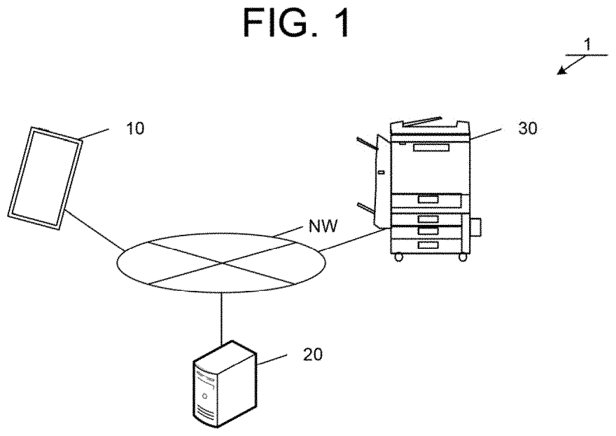

First, a description will be made on an overall configuration of a print system 1 in the present embodiment with reference to FIG. 1. As illustrated in FIG. 1, the print system 1 is configured that a terminal 10, a message server 20, and an image forming apparatus 30 are connected to each other via a network NW. Note that the network NW is illustrated as being connected via an external network such as the Internet, but a different connection configuration may be adopted. For example, the network NW may be connected by a local area network (LAN) or a different communicable method (such as the Internet network via the external network such as long term evolution (LTE)/5G).

The terminal 10 is an information processor operated by a user. The terminal 10 is configured by a device such as a smartphone, a tablet, or a personal computer (PC).

The terminal 10 is a device capable of exchanging messages with the image forming apparatus 30 as an external apparatus using an application (hereinafter referred to as a “messenger application”) for using a service capable of exchanging the message (hereinafter a “messaging service”). The messaging service may be provided as a single service, or may be provided as one of plural functions, such as a social networking service.

A user of the messaging service runs the messenger application and posts the message to the messaging service via the messenger application. The message in the present embodiment is data that is posted to the messaging service by the user who uses the messaging service. The message contains information such as information on a sender of the message, information on a destination of the message, and text of the message (a posted content).

The message that is posted to the messaging service is stored in the messaging service. The user of the messaging service requests the message, the destination of which is himself/herself, among the messages posted to the messaging service via the messenger application. The messaging service sends the message, the destination of which is the user who requests the message, to the terminal operated by the user. In this way, the message is exchanged.

The posted content contained in the message is text data entered by the user, for example. Alternatively, the posted content can be image data. In the present embodiment, the message, the posted content of which is the text data will be referred to as a text message, and the message, the posted content of which is the image data will be referred to as an image message.

The image data of the image message may be used as is as the posted content, or information on the image data may be used as the posted content. The information on the image data is information on a storage location of the image data (for example, a file path or a uniform resource locator (URL)) and attributes of the image data (for example, data size and a format of the image data, a hash value, and the like). In addition, the posted content may include a combination of these plural types of the information. When the image message, the posted content of which is the information on the image data, is posted, the image data is attached to the image message, and the image data is sent to the messaging service. In the case where the image data is attached to the message and the image data and the message are sent, the message and the image data may simultaneously be sent to the message server 20 or may be sent to the message server 20 at different timing. In either case, it is only necessary that the posted image data can be specified on the basis of the information on the image data contained in the posted content of the image message. In the case where the posted content of the image message is the information on the image data, the messenger application acquires the image data on the basis of the information on the image data. In the present embodiment, the image data is sent. However, in addition to the image data, content data, such as video data or audio data, that is displayed and the like when the messenger application executes display/playback processing may be sent.

Each of the information on the sender of the message and the information on the destination of the message may be information on an account. The account indicates the user who uses the messaging service. The information on the account is information with which the user who uses the messaging service can be specified, and is an account name, an e-mail address, or a serial number that can uniquely identify the user. Alternatively, the information on the account may be information, such as a combination of a user ID and the serial number, that includes plural types of the information. The destinations of the message may be the plural users. For example, as the destinations of the message, the plural account names may be contained, or information corresponding to the one or plural accounts, such as a name of a chat room or a talk room or a group name, may be contained.

In the present embodiment, assumed that the message contains the account names as the information on the sender of the message and the information on the destination of the message. A description will be made that the user as the destination and the user as the sender can be specified by the account names. The account name is a character string that includes alphabets, numbers, and symbols. The account name is determined by the user or the messaging service when the user uses the messaging service.

The message server 20 is a server that provides the messaging service, and stores the messages that are posted from the devices connected to the message server 20. When the message is requested from the device using the messaging service, the message server 20 sends the message to the device that requests the message. At this time, the message server 20 may send the message in which the user who uses the device requesting the message is designated as the destination.

The image forming apparatus 30 is an apparatus for forming an image that is based on the image data input from the outside on recording paper or the like. In the present embodiment, the image forming apparatus 30 forms the image, which is based on the image data contained in the message sent from the terminal 10 via the network NW, on the recording paper.

In the present embodiment, a description will he made that the message containing the text data, the image data, and information on the sender of the message and the destination of the message is posted (sent). However, as long as a format capable of specifying the sender, the destination, and the posted content is used, a message format may not he used. For example, when only the image data is posted (sent), the sender may he specified from an IP address of the user who posts the image data, and the destination may he specified from the name of the talk room that is displayed at the time when a posting operation of the image data is performed.

1.2 Functional Configuration

1.2.1 Terminal

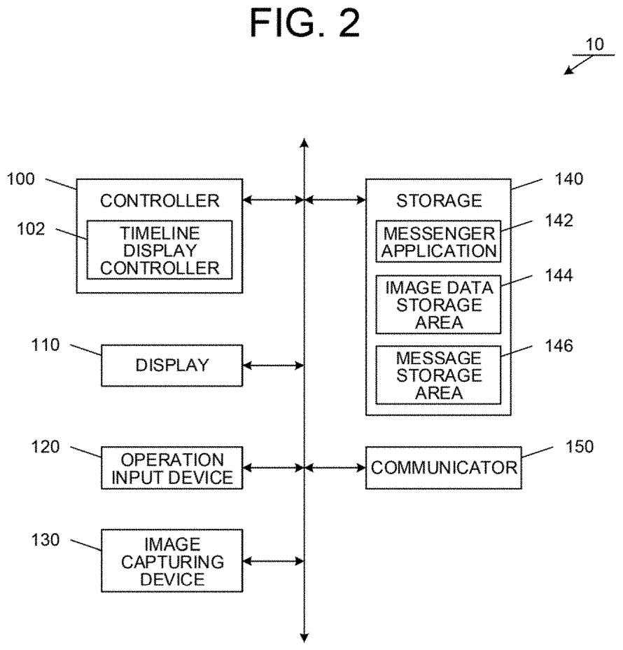

A description will he made on a functional configuration of the terminal 10 with reference to FIG. 2. As illustrated in FIG. 2, the terminal 10 is configured to include a controller 100, a display 110, an operation input device 120, an image capturing device 130, a storage 140, and a communicator 150.

The controller 100 is a functional unit that controls entirely the terminal 10. The controller 100 implements various functions when loading and executing various programs, and is constructed of one or plural central processing units (CPUs), for example.

The controller 100 also functions as a timeline display controller 102 by a messenger application 142, which will he described later. The timeline display controller 102 executes control to read the message that is stored in a message storage area 146, arrange the message in an order of message sending date/time, and display the message on the display 110. In the present embodiment, the arrangement and the display of the message in a chronological order, just as described, will be referred to as “timeline”. As the timeline, the timeline display controller 102 may display the message in a balloon or a specified figure. For example, when the message is the text message, the text data as the posted content may be displayed in the balloon. When the message is the image message, the image data based on the posted content may be displayed in the balloon.

The timeline display controller 102 may read the message, which is stored the message storage area 146, at specified tinning, and may redisplay (update) the timeline. The timeline display controller 102 may redisplay the timeline at the time when the message is sent or received, or may periodically redisplay the timeline. Alternatively, the timeline display controller 102 may redisplay the timeline at the time when the user performs an operation to redisplay the timeline.

The display 110 is a functional unit that displays the various types of the information to the user. For example, the display 110 is constructed of a liquid crystal display (LCD). The operation input device 120 is a functional unit that allows the user to perform various operations. For example, the operation input device 120 is constructed of a touchscreen that is superposed on the display 110. The touchscreen detects a touch by an electrostatic dielectric method, a pressure sensitive method, or a known technique. Here, the operation input device 120 may be constructed of various operation devices such as a mouse and a keyboard.

The image capturing device 130 is a functional unit that outputs, as the image data, the image input from an image input device such as a camera to the controller 100. The image input device may he provided in advance in the terminal 10 or ay he constructed of the image input device connected to the terminal 10.

The storage 140 is a functional unit that stores various programs required for operation of the terminal 10 and various types of the data. For example, the storage 140 is constructed of a solid-state drive (SSD) as semiconductor memory, a hard disk drive (HDD), and the like.

In the storage 140, a messenger application 142 is stored, and an image data storage area 144 and the message storage area 146 are further secured.

The messenger application 142 is an application that provides a function of exchanging the message with the messaging service. For example, the messenger application 142 has a function of posting (sending) the message, which contains the posted content by the user input from the operation input device 120, to the messaging service. The messenger application 142 has a function of displaying the message acquired from the messaging service as the timeline when making the controller 100 function as the timeline display controller 102.

The messenger application 142 may have a different function. For example, the messenger application 142 may have a function of managing the destination of the message and a function of displaying that the message is received on the display 110 when receiving the message.

The image data storage area 144 is an area for storing the image data. The image data stored in the image data storage area 144 is the image data output by the image capturing device 130 or the image data received by the communicator 150.

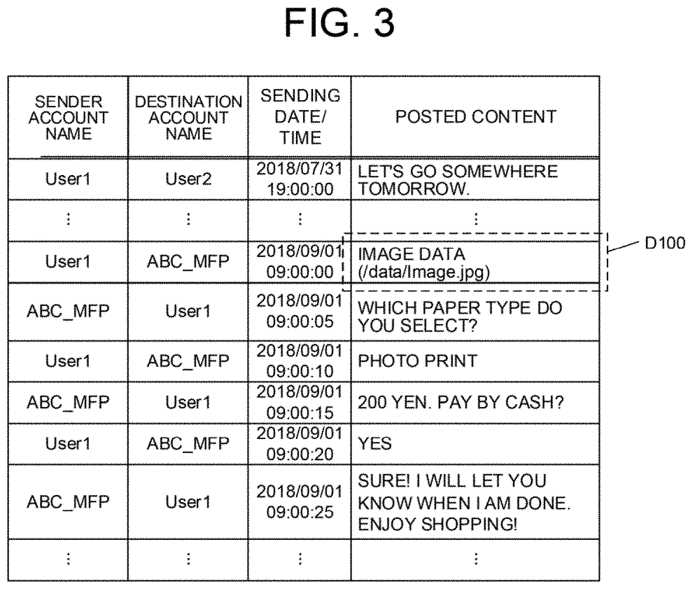

The message storage area 146 is an area for storing the messages exchanged via the messenger application 142. FIG. 3 is a table illustrating data configurations of the messages in the present embodiment. As illustrated in FIG. 3, in the message, a sender account name (for example, “User1”) for specifying the user who sends the message, a destination account name (for example, “User2”) for specifying the user as the destination of the message, the sending date/time (for example, “2018/10/31 19:00:00”) indicative of the message sending date/time, and the posted content entered by the user (for example, “LETS GO SOMEWHERE TOMORROW”) are stored.

The posted content may be the text data or the information on the image data. The information on the image data may be the image data itself or, as the information on the image data, may be a file name of the image data that is stored in the image data storage area 144 as in D100 of FIG. 3. The posted content may not be the content based on the user input and may be the content that is generated by a program or the like, for example.

The message may contain information other than the information such as the posted content, the destination account name, the sender account name, and the sending date/time. For example, the message may contain identification information for uniquely specifying the message, information indicative of whether the message is viewed, such as unseat, unread, or read, the hash value capable of verifying validity of the message, and the like.

The communicator 150 is a functional unit that allows the terminal 10 to communicate with an external device. For example, the communicator 150 is constructed of: a network interface card (NIC) used in the wireless LAN; and a communication module that can he connected to a long-term evolution (LTE)/LTE-advanced (LTE-A)/license assisted access (LAA) using LTE/5G line or the like.

1.2.2 Message Server

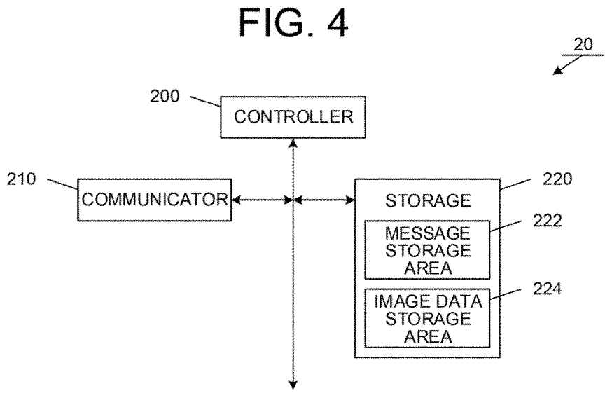

A description will be made on a functional configuration of the message server 20 with reference to FIG. 4. As illustrated in FIG. 4, the message server 20 is configured to include a controller 200, a communicator 210, and a storage 220.

The controller 200 is a functional unit that controls entirely the message server 20. The controller 200 implements various functions when loading and executing various programs, and is constructed of one or plural CPUs, for example.

The communicator 210 is a functional unit that allows the message server 20 to communicate with the external device. For example, the communicator 210 is constructed of the NIC used in the wireless LAN and a communication module that can be connected to the LTE/LTE-A/LAA/5G line or the like.

The storage 220 is a functional unit that stores various programs required for operation of the message server 20 and various types of the data. For example, the storage 220 is constructed of an SSD as the semiconductor memory, an HDD, and the like.

In the storage 220, a message storage area 222 and an image data storage area 224 are secured.

The message is stored in the message storage area 222. As the data configuration of the message, the message is stored per user or group. Here, the message itself is the same as the message stored in the message storage area 146. However, the message stored in the message storage area 222 may further contain information required for management and the like.

In the image data storage area 224, the image data that is sent as an attachment to the image message is stored. The image data storage area 224 stores the image data per user or group. As the image data, the image data that is he same as he image data stored in the image data storage area 144 is stored in association with the user.

1.2.3 Image Forming Apparatus

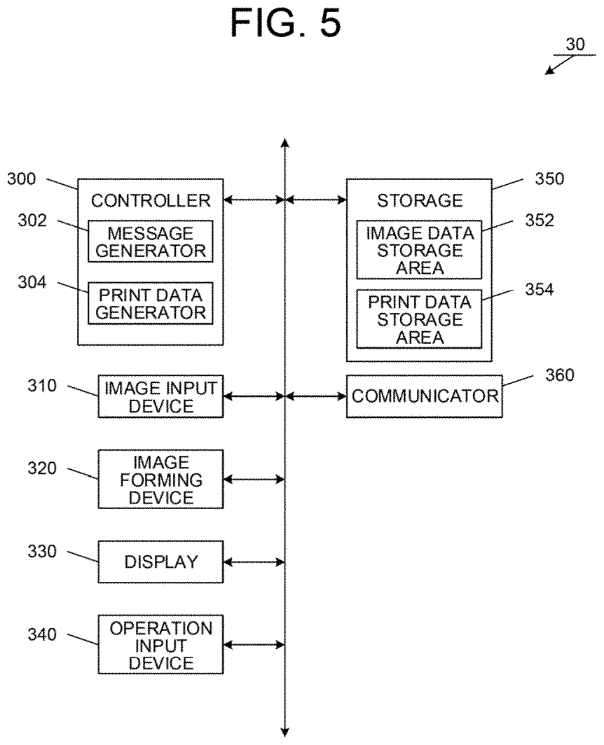

A description will be made on a functional configuration of the image forming apparatus 30 with reference to FIG. 5. As illustrated in FIG. 5, the image forming apparatus 30 is configured to include a controller 300, an image input device 310, an image forming device 320, a display 330, an operation input device 340, a storage 350, and a communicator 360.

The controller 300 is a functional unit that controls entirely the image forming apparatus 30. The controller 300 implements various functions when loading and executing various programs, and is constructed of one or plural CPUs, for example. The controller 300 functions as a message generator 302 and a print data generator 304 when loading and executing software (the program) stored in the storage 350.

The message generator 302 generates the message. For example, when acquiring the message from the message server 20 via the communicator 360, the message generator 302 generates a message indicative of a response to the message acquired. Then, the controller 300 sends the message, which is generated by the message generator 302, to the message server 20 via the communicator 360. The terminal 10 receives the message from the message server 20. In this way, the image forming apparatus 30 can respond to the message sent from the terminal 10.

The print data generator 304 generates print data on the basis of the image data stored in an image data storage area 352 and the message about print settings of the image data sent from the terminal 10. For example, the print data generator 304 enlarges/reduces the image data according to size of the recording paper and generates the print data. The print data generator 304 may generate the print data by combining plural types of the image data for aggregate printing, or may generate achromatic print data by converting colors from achromatic image data.

The image input device 310 is a functional unit that reads a document input to the image forming apparatus 30 and thereby generates the image data. For example, the image input device 310 is connected to a document reader (for example, a scanner) that reads a document image, and generates the image data output from the document reader. The image input device 310 may generate the image data on the basis of data (document data) that is sent from a different terminal via the communicator 360, or may import the image data from a storage medium such as universal serial bus (USB) memory, an SD card, or the like.

The image forming device 320 a functional unit that forms the image on a recording medium (for example, the recording paper) using the print data. For example, the image forming device 320 feeds the recording paper from a paper feed tray, forms the image on a surface of the recording paper, and discharges the recording paper on which the image is formed from a paper discharge tray. The g forming device 320 is constructed of a laser printer that, for example, adopts an electrophotographic method, or the like.

The display 330 is a functional unit that displays the various types of the information for the user. For example,the display 330 is constructed of the LCD, an organic electro-luminescence (EL) panel, or the like. The operation input device 340 is a functional unit that allows the user to perform various operations. For example, the operation input device 340 is constructed of the touchscreen that is superposed on the display 330. The touchscreen detects the touch by the electrostatic dielectric method, the pressure sensitive method, or the known technique.

The storage 350 is a functional unit that stores various programs required for operation of the image forming apparatus 30 and various types of the data. For example, the storage 350 is constructed of the SSD as semiconductor memory, the HDD, and the like.

In the storage 350, the image data storage area 352 and a print data storage area 354 are secured.

The image data storage area 352 is an area for storing the image data that is generated by the image input device 310. The print data storage area 354 is an area for storing the print data that is generated by the print data generator 304. Here, the print data is data that is used when the image forming device 320 forms the image on the recording paper, for example.

The communicator 360 is a functional unit that allows the image forming apparatus 30 to communicate with the external device. For example, the communicator 360 is constructed of the NIC used in the wireless LAN and the communication module that can be connected to the LTE/LTE-A/LAA/5G line or the like.

1.3 Processing Flow

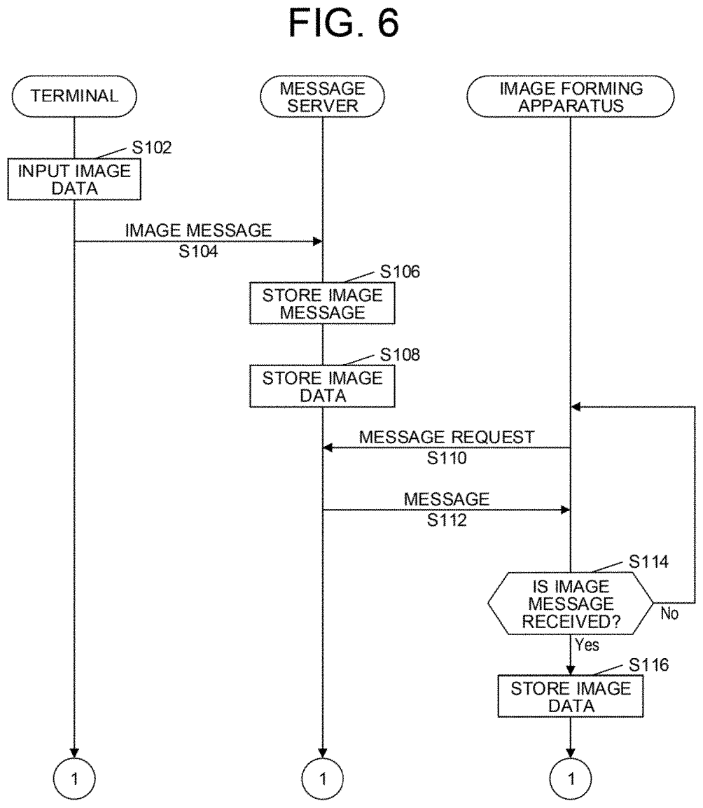

A description will be made on a processing flow in the present embodiment with reference to FIG. 6 to FIG. 8. The user of the terminal 10 and the image forming apparatus 30 are the users of the messaging service and are each assigned with the account name. Accordingly, the user of the terminal 10 and the image forming apparatus 30 can exchange the message via the messaging service. In addition, a description will be made that the posted content contained in the image message is the information on the image data and that the image data is attached to the image message and sent to the message server 20. In the following description, the account that corresponds to the user of the terminal 10 will simply be described as the user account name, and the account name that corresponds to the image forming apparatus 30 will be described as the account name of the image forming apparatus 30.

First, a description will be made on processing in which the terminal 10 sends the image data to the image forming apparatus 30 and the image forming apparatus 30 stores the image data with reference to FIG. 6. In FIG. 6, in the terminal 10, the controller 100 runs the messenger application 142 and is thereby brought into a state where the user can input the posted content.

First, the user of the terminal 10 inputs (selects) the image data as the posted content (S102). At this time, the controller 100 generates the image message and sends the image message to the message server 20 (S104). In the generated image message, information on the location of the image data input in S102 (for example, the file name) is set as the posted content, the user account name is set as the sender of the message, the account name of the image forming apparatus 30 is set as the destination of the message, and the sending date/time of the message is set as the sending date/time. In addition, the controller 100 sends the image data to the message server 20 at timing of sending the image message or different timing from the timing of sending the image message.

Next, the controller 200 of the message server 20 stores the image message, which is received from the terminal 10, in the message storage area 222 (5106). In addition, the controller 200 stores the image data, that is sent in the format as the attachment to the image message, in the image data storage area 224 (S108). At this time, the controller 200 may modify the information on the image data to the information on the location of the image data that is stored in the image data storage area 224. In this way, the device that receives the image message can acquire the image data stored in the image data storage area 224 on the bans of the information on the image data.

Then, the controller 300 sends a message request for requesting acquisition of the message to the message server 20 via the communicator 360 (S110). The message request may be sent periodically, or may be sent when a message notification, which is sent from the message server 20 or the server notifying reception of the message, is received. In addition, the message request may contain the sending date/time of the last message request and information for specifying the last acquired message. In this way, the controller 300 can request only the message sent newly instead of the message acquired already

When the controller 200 receives the message request from the image forming apparatus 30, the controller 200 sends the message to the image forming apparatus 30 via the communicator 210 (S112). Here, the controller 200 only sends the message, the destination account name of which is the account name corresponding to the image forming apparatus 30, to the image forming apparatus 30.

Next, the controller 300 determines whether the image message is received from the message server 20 (S114). As for whether the image message is received, the controller 300 may determine that the image message is received in the case where the posted content contained in the message is the information on the image data. If the image message is received, the controller 300 acquires the image data on the basis of the image message and stores the image data acquired in the image data storage area 352 (S114; Yes→S116). If the image message is not received, the controller 300 sends the message request to the message server 20 again at the specified timing (S114; No S110).

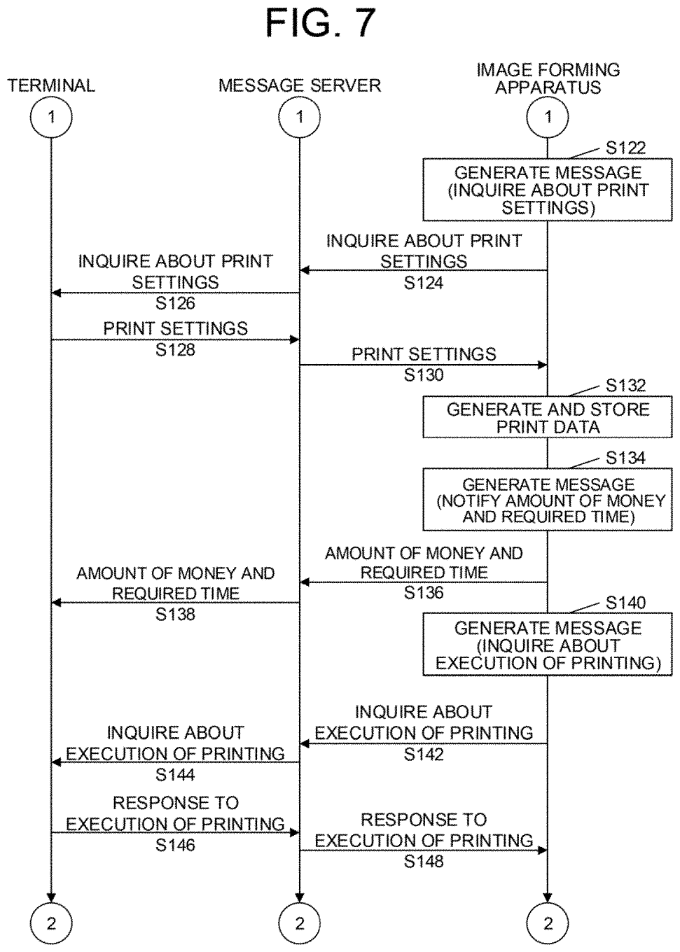

A description will he made on processing in which the terminal 10 instructs the image forming apparatus 30 to print the image data with reference to FIG. 7. First, in the case where the message generator 302 receives the image message from the message server 20, the message generator 302 generates the message that contains a content to inquire about the print settings (print conditions) as the posted content (S122). For example, the content to inquire about the print settings is the text data such as “WHICH PAPER TYPE DO YOU SELECT?” to inquire about a type of the recording paper on which the n age data is printed. In addition to the above, the content to inquire about the print settings may be the content to inquire about paper size, a color mode, or presence or absence of the aggregate printing. Here, the message that is generated by the message generator 302 in S122 contains the account name of the image forming apparatus 30 as the sender account name, the user account name as the destination account name, and the sending date/time of the message as the sending date/time.

Next, the controller 300 sends the message, which is generated by the message generator 302, to the message server 20 via the communicator 360 (S124). When receiving the message from the image forming apparatus 30, the controller 200 stores the received message in the message storage area 222. When receiving the message request from the terminal 10, the controller 200 sends the message to the terminal 10 (S126).

The controller 100 stores the message received from the message server 20 in the message storage area 146. Then, as a response to the inquiry about the print settings, the user of the terminal 10 inputs the content indicative of the print settings as the posted content. When being instructed to send the message, the controller 100 generates the message and sends the message to the message server 20 (S128). For example, the content indicative of the print settings is the text data of “PHOTO PRINT” that is a response to a setting inquiry message, “WHICH PAPER TYPE DO YOU SELECT?” The message generated by the controller 100 in S128 contains the user account name as the sender account name, the account name of the image forming apparatus 30 as the destination account name, and the sending date/time of the message as the sending date/time.

When receiving the message from the terminal 10, the controller 200 stores the received message in the message storage area 222. Then, when receiving the message request from the image forming apparatus 30, the controller 200 sends the message to the image forming apparatus 30 (S130).

Next, the print data generator 304 generates the print data on the basis of the print settings indicated in the posted content of the message received from the message server 20 and the image data stored in S108, and stores the print data in the print data storage area 354 (S132).

Then, the message generator specifies an amount of money and time required to output (print) the print data, and generates the message with a content notifying the amount of money and the required time as the posted content (S134). The content notifying the amount of money and the required time is the text data such as “THE AMOUNT IS 200 YEN, IT TAKES ABOUT 2 MINUTES FOR PRINTING.”, for example. Here, the message that is generated by the message generator 302 in S134 contains the account name of the image forming apparatus 30 as the sender account name, the user account name as the destination account name, and the sending date/time of the message as the sending date/time.

Next, the controller 300 sends the message, which is generated by the message generator 302, to the message server 20 via the communicator 360 (S136). When receiving the message from the image forming apparatus 30, the controller 200 stores the received message in the message storage area 222. When receiving the message request from the terminal 10, the controller 200 sends the message to the terminal 10 (S138).

The message generate 302 generates a message that has the content inquiring about execution of printing as the posted content (S140). For example, the content inquiring about the execution of printing is the text data “DO YOU WANT TO PRINT?” Here, the message that is generated by the message generator 302 in S140 contains the account name of the image forming apparatus 30 as the sender account name, the user account name as the destination account name, and the sending date/time of the message as the sending date/time.

Next, the controller 300 sends the message, which is generated by the message generator 302, to the message server 20 via the communicator 360 (S142). When receiving the message from the image forming apparatus 30, the controller 200 stores the received message in the message storage area 222. When receiving the message request from the terminal 10, the controller 200 sends the message to the terminal 10 (S144).

Then, the controller 100 stores the message, which is received from the message server 20, in the message storage area 146. Thereafter, as a response to the inquiry about the execution of printing, the user of the terminal 10 inputs the content indicative of the response to the execution of printing as the posted content. When being instructed to send the message, the controller 100 generates the message and sends the message to the message server 20 (S146). The content indicative of the response to the execution of printing is the text data that has the content indicative of whether printing is executed, for example. More specifically, the content indicative of the response to the execution of printing is the text data of “YES” as the response to the content of the inquiry about the execution of printing, “DO YOU WANT TO PRINT?” The response to the execution of printing may be the text data such as “CANCEL”, “NO”, “STOP” indicating that the execution of printing is canceled, or may be the text data such as “RESET” indicating that the print settings are reset. Here, the message, which is generated by the controller 100 in S146, contains the user account name as the sender account name, the account name of the image forming apparatus 30 as the destination account name, and the sending date/time of the message as the sending date/time.

When receiving the message from the terminal 10, the controller 200 stores the received message in the message storage area 222. Then, when receiving the message request from the image forming apparatus 30, the controller 200 sends the message to the image forming apparatus 30 (S148).

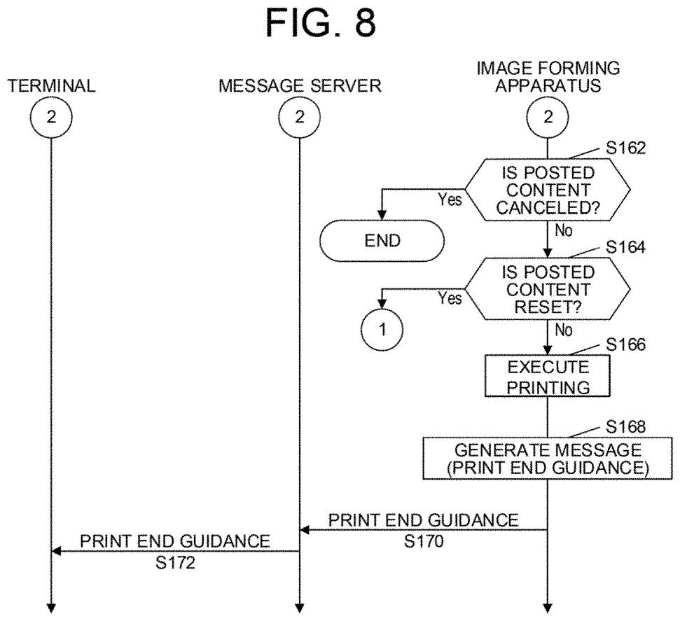

Next, a description will be made on processing in which the image forming apparatus 30 prints the print data based on the image data with reference to FIG. 8. First, the controller 300 determines the posted content of the message received in S148. The controller 300 determines whether the posted content is “CANCEL” indicating the cancellation of the execution of print g or a similar content thereto (S162). If the posted content is the content indicative of the cancellation of the execution of printing, the controller 300 terminates the processing and thus does not execute printing (S162: Yes).

Then, if the posted content is not the content indicative of the cancellation of the execution of printing, the controller 300 determines whether the posted content of the message received in S148 is “RESET” indicating that the print settings are reset or a Similar content thereto (S162; No→S164). If the posted content is the content indicating that the print settings a e reset, the processing returns to S122 (S164; Yes→S122).

If the posted content of the message received in S148 is neither the cancellation of the execution of printing nor resetting of the print settings, that is, if the posted content of the message received in S148 is the content indicative of the execution of printing, the controller 300 executes printing (S164; No→S166).

Then, when printing is completed, the message generator 302 generates a message that has a posted content of print end guidance (S168). For example, the print end guidance is the text data such as “PRINTING IS COMPLETED. PLEASE COME AND PICK UP AT MULTIFUNCTION PERIPHERAL”. Here, the message that is generated by the message generator 302 in S168 contains the account name of the image forming apparatus 30 as the sender account name, the user account name as the destination account name, and the sending date/time of the message as the sending date/time.

The controller 300 sends the message, which is generated by the message generator 302, to the message server 20 (S170). Then, when receiving the message from the image forming apparatus 30, the controller 200 stores the received message in the message storage area 222. When receiving the message request from the terminal 10, the controller 200 sends the message to the terminal 10 (S172). The controller 100 stores the message, which is received from the message server 20, in the message storage area 146.

In the above-described processing, an order of the steps may be changed, or at least one of the steps may not be executed or may be repeated. For example, in the case where the plural contents of the print settings are available (for example, in the case where the type of the recording paper and the color mode can be set as the print settings), the processing from S122 to S132 may repeatedly be executed, so as to inquire about the setting content of each of the print settings. In addition, in S134, only the information on the amount of money may be set as the message.

The description has been made that the message, the posted content of which is the inquiry about the print settings, the print settings, the amount of money and the required time, the inquiry about the execution of printing, the response to the execution of printing, or the print end guidance is sent. However, such a posted content may be set by a method other than the message. For example, the print end guidance may lie sent not in the form of the message but by an e-mail or a specified signal.

Furthermore, the processing may be changed according to a payment method of print fee. For example, in the case where the print fee can be paid via the messenger application 142, the controller 300 executes printing when the response to the execution of printing is the content indicative of the execution of printing. On the other hand, in the case where the print fee cannot be paid via the messenger application 142 and is paid by cash at the image forming apparatus 30, the image forming apparatus 30 stands by in a printable state even when the response to the execution of printing is the content indicative of the execution of printing. Then, after the print fee is paid, the image forming apparatus 30 executes printing.

1.4 Operation Example

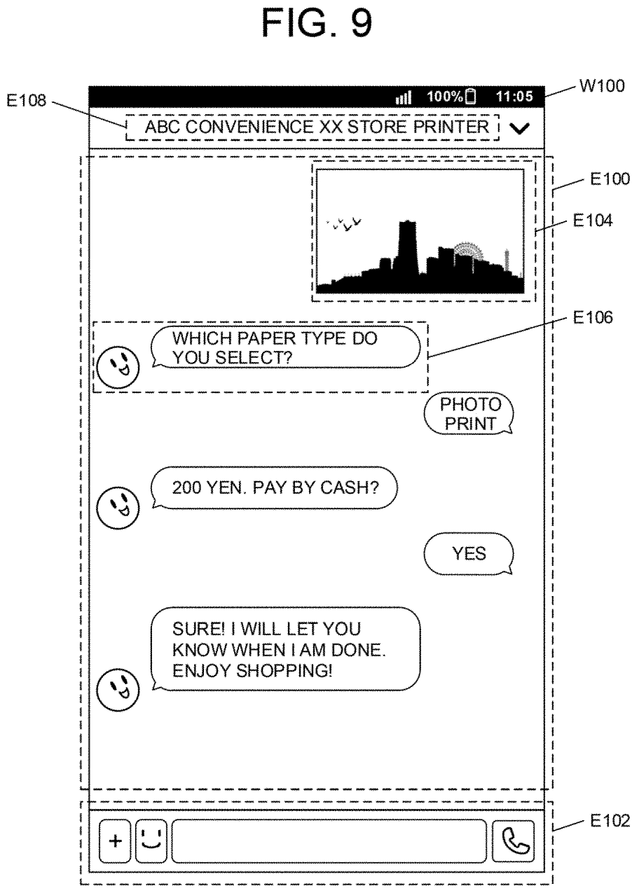

A description will be made on an operation example in the present embodiment with reference to FIG. 9. FIG. 9 is a view of an example of a display screen W100 that appears on the display 110 when the controller 100 loads and executes the messenger application 142. The display screen W100 includes: an area E100 where the timeline is displayed; and an area E102 in which the message is input and sent.

In the area E100 where the timeline is displayed, messages are displayed in the chronological order. The message may be displayed such that the sender can be distinguished. For example, as illustrated in FIG. 9, the messages whose sender is the user of the terminal 10 are displayed on a right side of the screen, and the messages whose sender is the image forming apparatus 30 are displayed on a left side the screen. In this way, conversation between the terminal 10 and the image forming apparatus 30 can be presented visually to the user of the terminal 10. As the display to distinguish the sender, a background color and the background shape of the area where the message is displayed may be changed, a character color may be changed, or information on the sender (for example, the account name) may be displayed. Alternatively, some of the display methods may be combined.

In the timeline, like an area E104 where the image data is displayed anal an area. E106 where the posted content of the text message is displayed, the area There the display based on the posted content is provided is secured for each of the messages. Every time the message is stored in the message storage area 146, the controller 100 updates the area E100 where the message is displayed. In this way, the messages exchanged between the terminal 10 and the image forming apparatus 30 are presented to the user of the terminal 10. A partner (the destination) with whom the messages are exchanged may be indicated by an icon as in the area E106 or may be indicated by his/her name (for example, a user name). Information on the partner name or the partner icon may be contained in the message, and the partner name or the partner icon may be stored in the storage 140.

In the present embodiment, the description has been made on the case where the image data that is based on the posted content of the image message is output by printing. However, the image data may be output by any of various other methods. For example, the image data may be output as a portable document format (PDF) format file, the image data may be attached to the e-mail and output to the destination, or the image data may be output as a facsimile (FAX) document to a FAX destination.

According to the present embodiment, the user can print (output) the posted image data from the image forming apparatus only by posting the image data to the messaging service and making the print settings. Thus, user registration for the network print service is unnecessary for the user. In addition, the user does not have to input information such as a user number or a document number in the multifunction peripheral. Therefore, it is possible to improve convenience of the user.

### 2. Second Embodiment

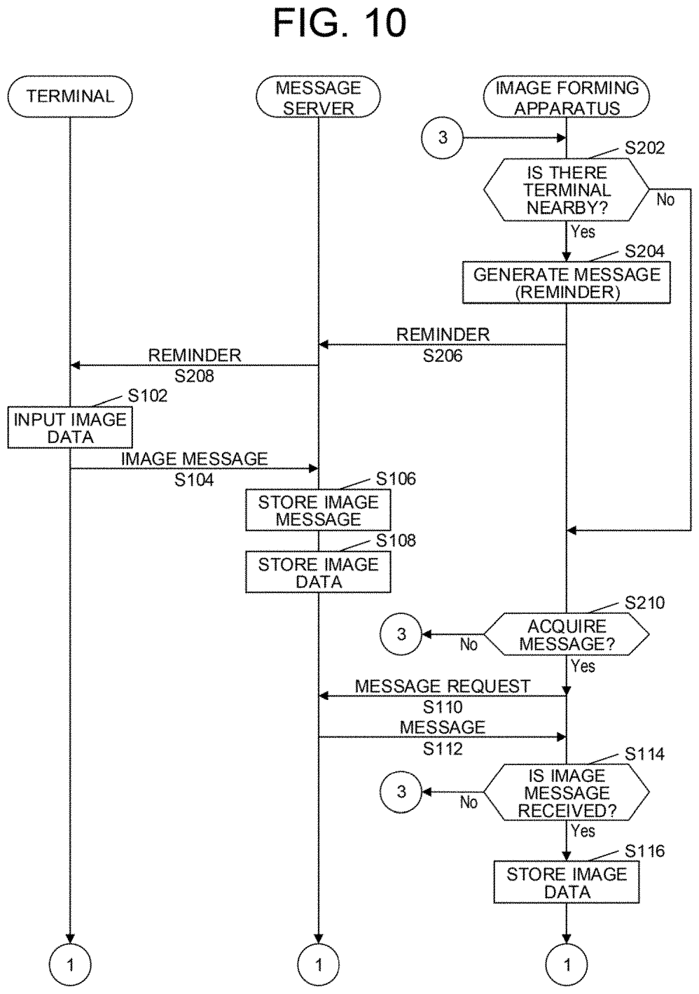

Next, a description will be made on a second embodiment. The second embodiment is an embodiment in which, in addition to the processing in the first embodiment, the image forming apparatus 30 sends a reminder in the case where the user of the terminal 10 is at an installed location of the image forming apparatus 30. In the present embodiment, FIG. 6 in the first embodiment is replaced with FIG. 10. The same functional units and the same processing will be denoted by the same reference numerals, and a description thereon will not be made.

2.1 Processing Flow

A description will be made on a processing flow in the second embodiment with reference to FIG. 10. It is assumed that the user of the terminal 10 and the image forming apparatus 30 are the users of the messaging service and are each assigned with the account name. In add on, the user of the terminal 10 and the image forming apparatus 30 are in a state capable of exchanging the messages.

First, the controller 300 determines whether the terminal 10 capable of exchanging the message is located near the image forming apparatus 30 (S202). In order to determine whether the terminal 10 is located near the image forming apparatus 30, a beacon device capable of short-range wireless communication with the terminal 10 is installed near the installed location of the image forming apparatus 30, for example. In the case where the beacon device can communicate with the terminal 10, the beacon device notifies the image forming apparatus 30 that the terminal 10 is located near the image forming apparatus 30. The image forming apparatus 30 determines that the terminal 10 is located near the image forming apparatus 30 on the basis of the notification from the beacon device.

A method other than the above may be adopted. For example, the controller 300 may acquire global positioning system (GPS) information of the terminal 10 to determine whether the terminal 10 is located near the image forming apparatus 30. Alternatively, in the case where the short-range wireless communication between the terminal 10 and the image forming apparatus 30 can be established, the controller 300 may determine whether the terminal 10 is located near the image forming apparatus 30.

In the case where the terminal 10 capable of exchanging the message is located near the image forming apparatus 30, the message generator 302 generates the message that has the posted content indicative of the reminder for the user (S204). The message having the content indicative of the reminder is the message for notifying the user of the terminal 10 that the image forming apparatus 30 is installed nearby. For example, such a message has the text data, “THANK YOU FOR COMING TO STORE! DO YOU WANT TO PRINT?” The message that is generated by the message generator 302 in S204 contains the account name corresponding to the image forming apparatus 30 as the sender account name, the account name corresponding to the user of the terminal 10 as the destination account name, and the sending date/time of the message as the sending date/time.

Then, the controller 300 sends the message, which is generated by the message generator 302, to the message server 20 via the communicator 360 (S206). When receiving the message from the image forming apparatus 30, the controller 200 store the message in the message storage area 222. When receiving the message request from the terminal 10, the controller 200 sends the message to the terminal 10 (S208). The controller 100 stores the message, which is received from the message server 20, in the message storage area 146. The timeline display controller 102 displays the timeline that is based on the message stored in the message storage area 146. In this way, the user of the terminal 10 can check a content of the reminder received from the image forming apparatus 30.

On the other hand, if the terminal 10 is not located near the image forming apparatus 30 in S202, next, the controller 300 determines whether it is timing to acquire the message (S210). If it is the timing to acquire the message, the controller 300 sends the message request to the message server 20 (S210; Yes S110). Then, the controller 300 executes the processing in S110 onward. If it is not the timing to acquire the message, the processing returns to S202 (S210; No→S202).

2.2 Operation Example

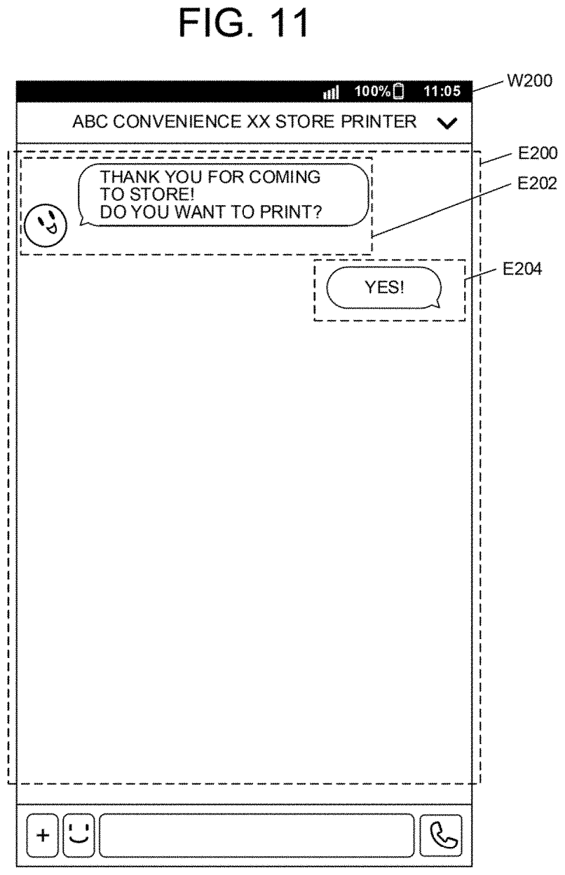

A description will be made on an operation example in the present embodiment with reference to FIG. 11. FIG. 11 is a view of an example of a display screen W200 that appears on the display 110 when the controller 100 loads and executes the messenger application 142.

The display screen W200 includes an area E200 for displaying the timeline. Here, when determining that the terminal 10 is near the installed location of the image forming apparatus 30, the image forming apparatus 30 sends the message that has the content of the reminder (hereinafter referred to as a “reminder message”) to the terminal 10. As a result, in an area E202 where the posted content of the text message is displayed in the area E200, the posted content of the reminder message is displayed.

The user of the terminal 10 may respond to the reminder message. For example, in the case where the user of the terminal 10 respond “YES!” to the reminder message, the posted content of the text message, which is sent as the response, is displayed in an area E204 where the posted content of the text message is displayed in the area. E200. In addition, the message indicating the response to the reminder message is sent to the image forming apparatus 30. When receiving the response message to the reminder message, the image forming apparatus 30 may generate the message for providing a print guide and send the message to the terminal 10.

The image forming apparatus 30 may send the reminder message in the case where the user posts the image message, the destination of which is the image forming apparatus 30, but has not executed printing, and the terminal owned by such a user is located nearby. At this time, as the posted content of the reminder message may be a content that promotes printing of the image data contained in the already-posted image message (for example, the text data, “WELCOME! YOU STILL HAVE UNPRINTED IMAGE DATA.”). In addition, similar to the first embodiment, the reminder may not be sent in the form of the message but may be sent by the e-mail or a specified signal.

According to the present embodiment, when the user who has posted the image data visits a store or the like where the image forming apparatus 30 is installed, it is possible to make the user aware of existence of the image forming apparatus 30. In this way, it is possible to improve a usage rate of the image forming apparatus 30.

### 3. Third Embodiment

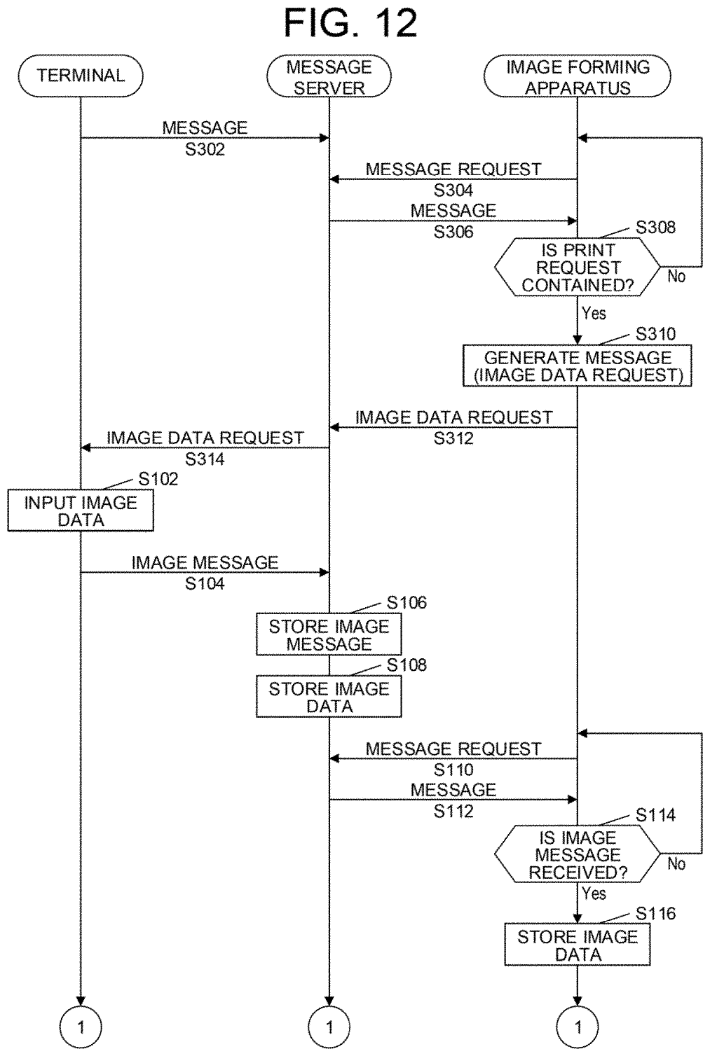

A third embodiment is an embodiment in which the image forming apparatus 30 generates and sends a message that promotes the user to post the image message to be printed. In the present embodiment, FIG. 6 in the first embodiment is replaced with FIG. 12. The same functional units and the same processing will be denoted by the same reference numerals, and a description thereon will not be made.

In the present embodiment, the message generator 302 manages a state whether the image forming apparatus 30 can accept the image data as a print target. Then, the image data that is received in the state where the image forming apparatus 30 accepts the image data as the print target is set as the image data as the print target.

3.1 Processing Flow

A description will be made on a processing flow in the present embodiment with reference to FIG. 12. It is assumed that the user of the terminal 10 and the image forming apparatus 30 are the users of the messaging service and are each assigned with the account name. In addition, the user of the terminal 10 and the image forming apparatus 30 are in the state capable of exchanging the messages. Furthermore, it is assumed that the state of the image forming apparatus 30 is a state of not accepting the image data as the print target.

First, the controller 100 sends the message with the account name of the image forming apparatus 30 as the destination account name to the message server 20 (S302). The controller 300 sends the message request to the message server 20 and receives the message from the message server 20 (S304→S306).

Next, the controller 300 determines whether the print request is contained in the posted content of the message (S308). For example, the print request is a character string such as “I WANT TO PRINT.”. If the print requests contained in the posted content of the message, the controller 300 brings the image forming apparatus 30 into a state of accepting the image data as the print target. Then, the message generator 302 generates a message that has a content requesting the image data as the posted content (S310). The content requesting the image data is the text data that promotes posting of the image message and, for example, is the text data such as “PLEASE UPLOAD IMAGE YOU WANT TO PRINT.”. The message that is generated by the message generator 302 in S310 contains the account name corresponding to the image forming apparatus 30 as the sender account name, the account name corresponding to the user of the terminal 10 as the destination account name, and the sending date/time of the message as the sending date/time.

Then, the controller 300 sends the message, which is generated by the message generator 302, to the message server 20 via the communicator 360 (S312). When receiving the message from the image forming apparatus 30, the controller 200 stores the message in the message storage area 222. When receiving the message request from the terminal 10, the controller 200 sends the message to the terminal 10 (S314). The controller 100 stores the message, which is received from the message server 20, in the message storage area 146. The timeline display controller 102 displays the timeline that is based on the message stored in the message storage area 146. In this the user of the terminal 10 can check the content of the image data request received from the image forming apparatus 30.

In the case where the message that does not contain the print request is received in S308, the controller 300 may generate the message that contains the response to the received message or a net print service guide as the posted content. In addition,the controller 300 may send the generated message, the destination of which is the terminal 10, to the message server 20 (S308; No),

In addition, in the case where the controller receives the image message from the terminal 10 after S312, the controller 300 may be brought back into the state of not accepting the image data as the print target. In this way, even in the case where the image message is sent while the messages related to the print settings are exchanged, it is possible not to handle the image data that is posted after the reception of the image message as the image data as the print target. Here, the controller 300 may maintain the state of accepting the image data until print setting is completed. In such a case, in the case where th message is already received but the image message is newly sent, instead of the image data that is received in the past, the image data that is based on the posted content of the newly-received image message can be handled as the image data as the print target.

3.2 Operation Example

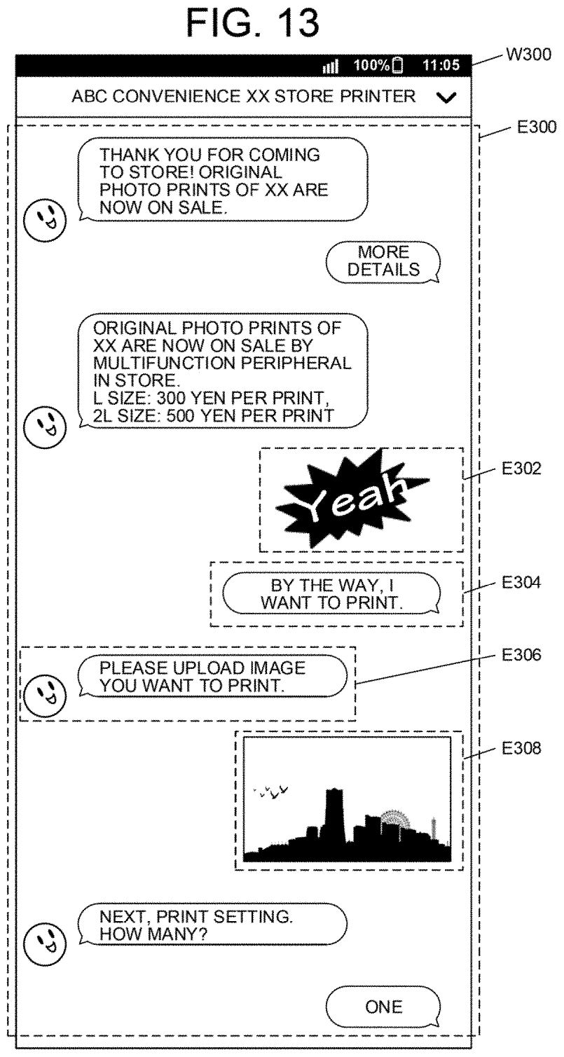

A description will be made on an operation example in the present embodiment with reference to FIG. 13. FIG. 13 is a view of a example of a display screen W300 that appears on the display 110 when the controller 100 loads and executes the messenger application 142.

The display screen W300 includes an area E300 where the timeline is displayed. In the case where the image forming apparatus 30 is in the state of not accepting the image data as the print target, the image forming apparatus 30 sends the message that contains the net print service guide or the message as the response to the message from the user. As illustrated in an area E302, there is a case where the user sends the image message or the message containing the image data that can only be used in the messenger application (for example, a stamp or a sticker) as the posted content. Since the image forming apparatus 30 is in the state of not accepting the image data until the image forming apparatus 30 receives the message containing the print request from the terminal 10, the image data, which is contained in the message sent from the user in such a state, is not handled as the image data as the print target.

Next, as illustrated in an area E304, in the case where the user sends the message containing the print request, the image forming apparatus 30 is brought into the state of accepting the image data, and sends the message that requests the image data as illustrated in an area E306. Then, as illustrated in an area E308, in the case where the user sends the image message, the image forming apparatus 30 handles the image data, which is based on the posted content of the image message, as the image data as the print target.

According to the present embodiment, it is possible to make clearly specify the message for accepting the image data as the print target to the user.

### 4. Fourth Embodiment

A fourth embodiment is an embodiment in which the image forming apparatus 30 makes a response in a dialect on the basis of the installed location of the image forming apparatus 30 or information on an installed store or the like.

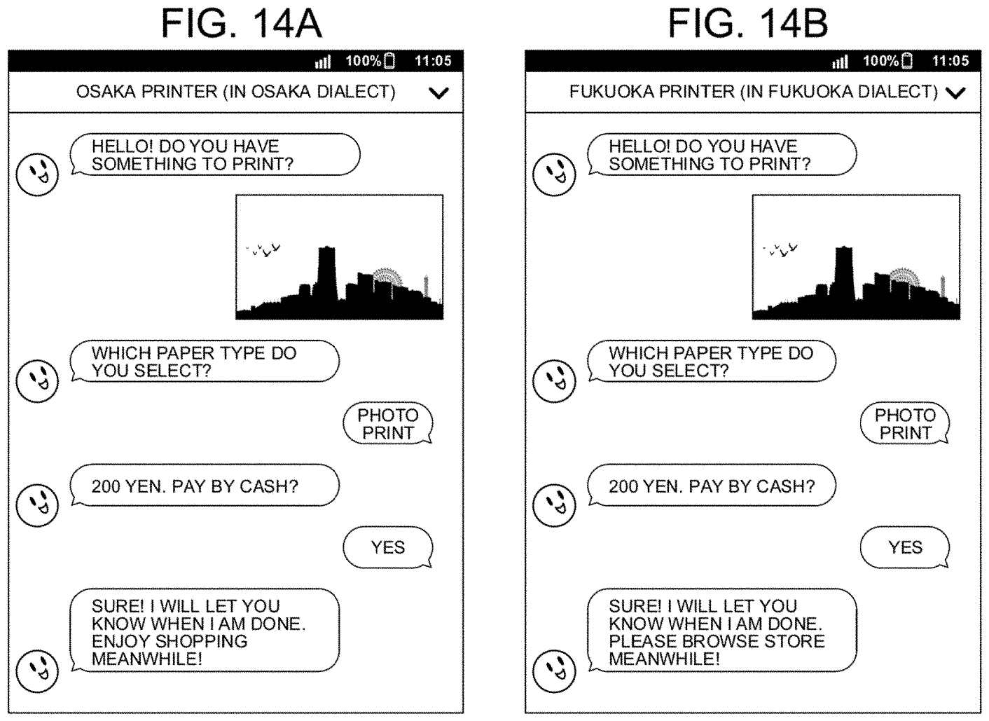

Operation examples in the present embodiment are illustrated in FIGS. 14A and 14B. FIG. 14A is a screen example that displays the messages exchanged between the image forming apparatus 30 installed in Osaka and the user in the timeline format. As illustrated in FIG. 14A, each of the messages sent from the image forming apparatus 30 contains the text data that is based on the dialect used in Osaka and Kansai region. FIG. 14B is a screen example that displays the messages exchanged between the image forming apparatus 30 installed in Fukuoka and the user in the timeline format. As illustrated in FIG. 14B, each of the messages sent from the image forming apparatus 30 contains the text data that is based on the dialect used in Fukuoka and Kyushu region.

In the present embodiment, the message generator 302 generates the text data that is based on the installed location of the image forming apparatus 30 or the information on the installed store or the like. For example, the storage 350 stores data in which the text data in a standard language corresponds to the text data in the corresponding dialect. When making a response, the message generator 302 retrieves the text data in the dialect that corresponds to the text data to be sent as the original response, and generates the message that has the text data in the dialect as the posted content.

According to this embodiment, the image forming apparatus 30 can make the response rooted in the region, and thus can enhance appeal to the user.

### 5. Fifth Embodiment

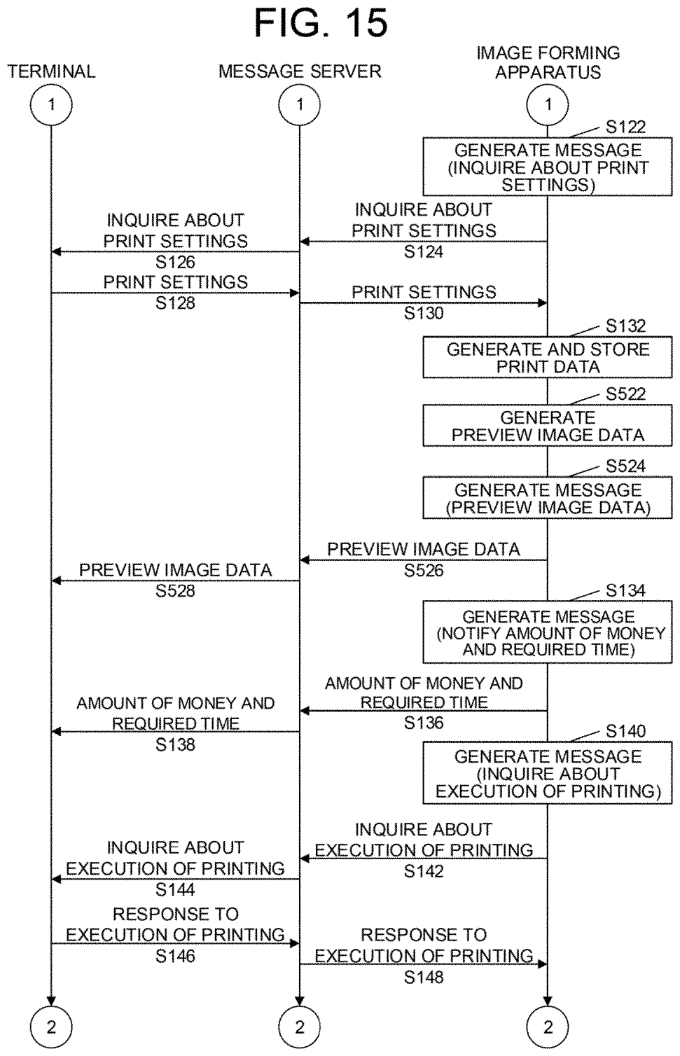

A fifth embodiment is an embodiment in which the image forming apparatus 30 provides an image as a print preview when receiving the message of a preview display request from the user. In the present embodiment, FIG. 7 in the first embodiment is replaced with. FIG. 15. The same functional units and the same processing will be denoted by the same reference numerals, and a description thereon will not be made.

A processing flow in the present embodiment will be illustrated in FIG. 15. When generating the print data, the controller 300 generates preview image data that, is the image data indicative of the print preview (S522). Meanwhile, the message generator 302 generates a message (the image message) that has the preview image data as the posted content (S524). The message that is generated by the message generator 30 in S524 contains the account name corresponding to the age fort ng apparatus 30 as the sender account name, the account name corresponding to the user of the terminal 10 as the destination account name and the sending date/time of the message as the sending date/time.

The preview image data is the image data that reflects the contents of the print settings to the image data as the print target on the basis of the message sent from the user so far. The controller 300 converts the print data stored in the print data storage area 354 to the print data format and generates the preview image data. The controller 300 may read the image data as the print target from the image data storage area 352 and reflect the contents of the print settings specified by the user so far, so as to generate the preview image data.

Next, the controller 300 sends the message, which is generated by the message generator 302, to the message server 20 (S526). When receiving the message from the image forming apparatus 30, the controller 200 stores the message in the message storage area 222. When receiving the message request from the terminal 10, the controller 200 sends the message to the terminal 10 (S528).

When the timeline display controller 102 in the terminal 10 reads the image message that contains the preview image data as the posted content, the preview image data is displayed in the timeline. The user can check the image of the image data after printing by the preview image data.

The controller 300 may send the preview image data every time the print settings are changed, or may send the preview image data when receiving a preview request message. The preview request message is the message that has the content for checking the print preview as the posted content. For example, the text for checking the preview such as “LET ME CHECK PREVIEWS.” is the text message contained in the posted content.

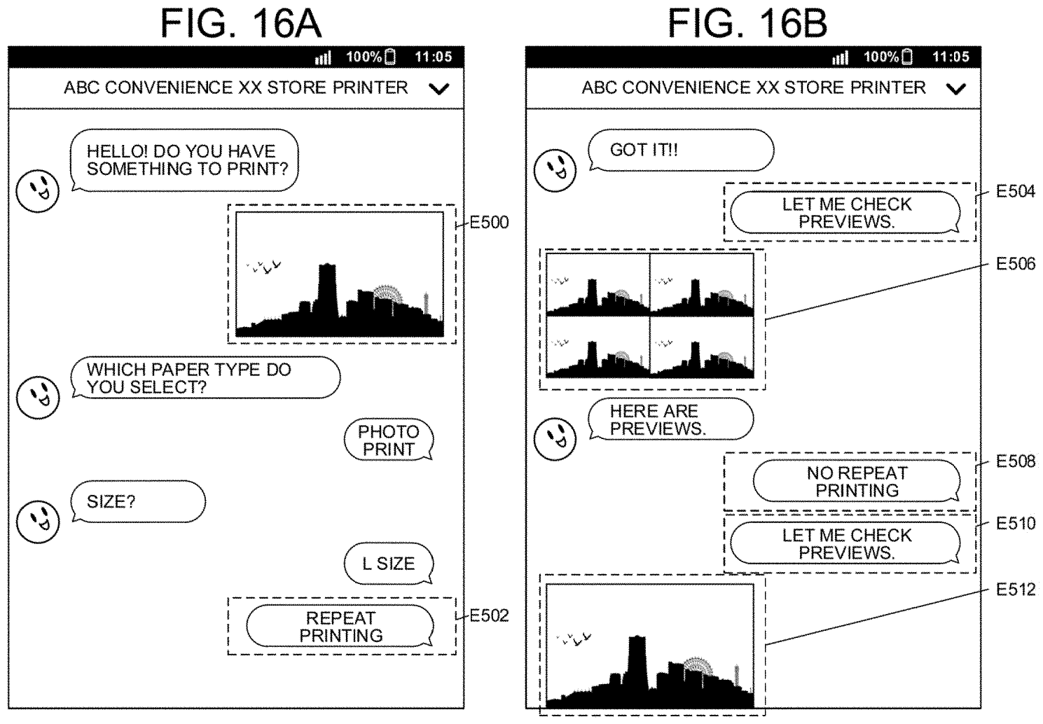

An operation example in the present embodiment is illustrated in FIGS. 16A and 16B. Here, FIGS. 16A and 16B illustrate the continuous timeline. As illustrated in an area E500 of FIG. 16A, it is assumed that the user sends the image message. Furthermore, as illustrated in an area E502, it is assumed that the user sends the message requesting repeat printing as the print setting.

As illustrated in an area E504 of FIG. 16B, in the case where the user sends the preview request message, the controller 300 sends the message that has the image representing the print preview as the posted content. As a result, as illustrated in an area E506, the image data representing the print preview of a case where the image data sent by the user is repeatedly printed is displayed in the time line.

In addition, as illustrated in an area E508, it is assumed that the user sends the message not requesting the repeat printing. Furthermore, as illustrated in an area. E510, it is assumed that the user sends the preview request message. Also, in this case, the controller 300 sends the message that has the image representing the print preview as the posted content. As a result, as illustrated in an area E512, the image data representing the print preview of a case where the image data sent by the user is not repeatedly printed is displayed in the timeline.

Just as described, the user can make the print settings while looking at the image data representing the print previews displayed in the area E506 and the area. E512.

According to the present embodiment, when receiving the preview request message, the image forming apparatus 30 can provide the user with the image data representing the print preview. The user can adjust the print settings while checking the image after printing at hand. Therefore, the image forming apparatus 30 can perform printing suitable for the user's needs.

### 6. Sixth Embodiment

A sixth embodiment is an embodiment in which the image forming apparatus 30 exchanges the messages by using selection buttons as the message for exchanging with the user. For example, in the case where the image forming apparatus 30 inquires of the user about the print settings such as the paper size, presence or absence of the repeat printing, the number of the repeat printing,and the color mode, the image forming apparatus 30 sends the message, which has the posted content for exchanging by the selection buttons, as the setting inquiry message. In this case, when generating the setting inquiry message, the message generator 302 the message that has the content for exchanging by the selection buttons as the posted content.

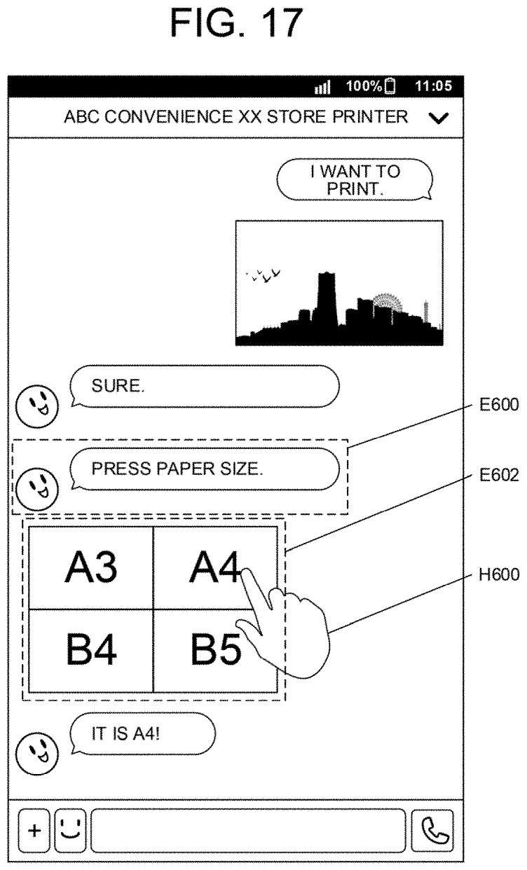

An operation example in the present embodiment is illustrated in FIG. 17. As illustrated in an area E600 of FIG. 17, the message generator 302 generates and sends the setting inquiry message that promotes setting of the paper size as the print setting in the case where the image data is printed. At this time, as the posted content of the setting inquiry message generated by the message generator 302, the selection buttons are displayed, and information used to make the user select the selection button is contained. As a result, as illustrated in an area E602, buttons for selecting any one of A3, A4, B4, and B5 as the paper size are displayed in the timeline.

The user uses a hand H600 to select any one of the buttons. When the user selects any one of the buttons, the messenger application 142 generates the message that contains information on the selected button as the posted content, and sends the message, the destination of which is the image forming apparatus 30, to the message server 20. When receiving the message that contains the information on the selected button as the posted content, the image forming apparatus 30 executes processing according to the selected button. For example, the image forming apparatus 30 makes the print setting corresponding to the selected button, or sends the message as the response.

According to the present embodiment, the image forming apparatus 30 can exchange with the user so as to reduce time and effort for inputting the text data. Therefore, improvement in the convenience of the user can be expected.

### 7. Modified Embodiments

The present invention is not limited to each of the above-described embodiments, and various modifications can be made thereto. That is, an embodiment that can be acquired by combining technical means that are appropriately changed within the scope that does not depart from the gist of the present invention is also included in the technical scope of the present invention.

In addition, the above-described embodiments are separately described for convenience of the description. However, it is needless to say that they can be combined and executed within the scope that is technically possible.

The program run in each of the devices in the embodiments is the program for controlling the CPU and the like (the program that makes the computer function) so as to achieve the functions in the above-described embodiments. The information handled by these devices is temporarily stored in a temporary storage device (such as the RAM) at the time of processing, is then stored in the storage device such as any of the various types of the ROM and the HDD, is read by the CPU for modification and writing when necessary.

Here, the recording medium that stores the program may be any of a semiconductor medium (for example, the ROM, a non-volatile memory card, or the like), an optical recording medium, a magneto-optical recording medium (for example, a digital versatile disc (DVD), a magneto optical disc (MO), a minidisc (MD), a compact disc (CD), a Blu-ray® disc (BD), or the like), a magnetic recording medium (for example, a magnetic tape, a flexible disk, or the like), and the like. In addition, when the loaded program is run, not only the functions in the above-described embodiments are realized, the processing is executed in cooperation with an operating system, a different application program, or the like on the basis of a command from the program. In this way, the functions of the present invention may be exerted.

In addition, in order to distribute the program in the market, the program is stored in a portable recording medium for distribution, or the program can be transferred to a server computer that is connected via the network such as the Internet. In this case, it is needless to say that the storage device of the server computer is included in the present invention.

What is claimed is:

1. An image forming apparatus capable of being connected to a messaging service that displays a message in a chronological order in timeline, the image forming apparatus comprising:
an acquisition device that acquires an image displayed in the timeline; and
a printer that prints the image acquired.

2. The image forming apparatus according to claim 1, wherein
the acquisition device acquires a print condition from the timeline, and.
the printer prints the image according to the print condition.

3. An image forming method comprising:
being connected to a messaging service that displays a message in a chronological order in timeline and acquiring an image displayed in the timeline; and printing the image acquired.

4. A non-transitory computer-readable recording medium storing a program that causes a computer to implement:
an acquisition function of being connected to a messaging service that displays a message in a chronological order in timeline and acquiring an image displayed in the timeline: and
a printing function of printing the image acquired.

5. A print system comprising: a terminal capable of being connected to a messaging service that displays a message in a chronological order in timeline; and an image forming apparatus, wherein
the terminal includes:
a display that displays the message in the chronological order in a timeline screen; and
a sending device that sends an image displayed in the timeline to the messaging service, and
the image forming apparatus includes:
an acquisition device that acquires the image sent to the messaging service; and
a printer that prints the image acquired.
